(19) United States
(12) Patent Application Publication
(10) Pub. No.: US 2013/0085093 A1
(43) Pub. Date: Apr. 4, 2013

(54) AQUEOUS CLEANING AGENT COMPOSITION

(71) Applicants: Yusaku Ishihara, Kariya-shi (JP); Hideyuki Yamamoto, Kariya-shi (JP)

(72) Inventors: Yusaku Ishihara, Kariya-shi (JP); Hideyuki Yamamoto, Kariya-shi (JP)

(73) Assignee: YUKEN INDUSTRY CO., LTD., Kariya-shi, Aichi (JP)

(21) Appl. No.: 13/697,817

(22) PCT Filed: May 12, 2011
(86) PCT No.: PCT/JP2011/060950

§ 371 Date: Dec. 11, 2012

(30) Foreign Application Priority Data
May 14, 2010 (JP) 2010-112302

(51) Int. Cl. C11D 3/37

(52) U.S. Cl. CPC C11D 3/3765
USPC 510/245

(57) ABSTRACT

As a general-purpose aqueous cleaning agent composition which has excellent oil separability adaptable even to water soluble machining oils, the present invention provides an aqueous cleaning agent composition including an emulsifying agent that removes an oil component from a member subjected to cleaning to which the oil component is adhering and emulsifies the oil component, a separating agent comprised of an anionic polymer and a separating auxiliary agent comprised of a cationic surfactant. It is preferred that the molecular weight of the anionic polymer is 1500 to 50000. It is also preferred that the HLB value of the separating auxiliary agent is a value of 26 or more as defined by the Davies' method.

### TECHNICAL FIELD

The present invention relates to a cleaning agent composition and particularly to an aqueous cleaning agent composition which can achieve excellent oil separability even for water-soluble cutting oil that contains a surface activating component.

### BACKGROUND ART

A cleaning process is performed for the purpose of removing oil contents which are adhering to surfaces of parts, such as metallic parts, before and after a heat-treatment process, a machining process such as cutting, and a surface-treatment process.

Heretofore, in such a cleaning process, organic solvents such as chlorofluorocarbon-based solvent (fluorinated hydrocarbon), chlorinated solvent (such as trichloroethane) have primarily been used. However, such organic solvents have substantially been prohibited to be used because of imposing a large environmental load. In this respect, an aqueous cleaning agent which contains water as a main solvent is currently primarily used.

Such an aqueous cleaning agent is based on an underlying principle that a surfactant or other appropriate agent is used for dispersing oil components into an aqueous liquid, i.e. emulsifying them, such as by removing oil components from a member to be an object subjected to cleaning (referred to as “member subjected to cleaning” in the present invention) to which the oil components are adhering, and by causing the oil components removed from the member subjected to cleaning to be fine particles, and further by causing them to be enclosed in the surfactant and to be particles (micelles) having micelle structures. In the present invention, oil components in the state of being thus dispersed in liquid are referred to as “emulsified oil components”, and oil drops comprised of the emulsified oil components, and micelles that contain the oil drops are referred to as “oil-based dispersed particles”.

If, however, the emulsified oil components are dispersed as the oil-based dispersed particles in liquid, then it may be problematic that, when a member having been cleaned is taken out from a cleaning bath, the oil-based dispersed particles re-adhere to the surface of the member thereafter being carried out to the subsequent water washing process, and the cleaning process deteriorates in its cleaning ability and hence a large cleaning load is imposed to the water washing process as well as the load in effluent treatment is increased.

In order to solve such problems, it is preferred that the oil components once removed from the surface of the member subjected to cleaning are rapidly separated from a liquid phase comprised of aqueous liquid (referred hereinafter to as “aqueous liquid phase”) rather than that the emulsified oil components continue to be suspended in the cleaning agent. If the emulsified oil components can be separated as an oil phase in this way, then only the oil phase can efficiently be removed from the cleaning liquid by using an appropriate method such as overflowing. In addition, removing the emulsified oil components from the cleaning agent in such a manner allows for extending the life of the cleaning agent.

However, as apparent from the above underlying principle in cleaning, the oil components on the surface of the member subjected to cleaning must be emulsified for being removed. Therefore, the oil-based dispersed particles may have to be formed once in the cleaning agent thereafter being separated from the aqueous liquid phase, as an oil phase obtained by aggregating them. In order to achieve such a process, separating components for separating the emulsified oil components from the aqueous liquid phase are required to be designed as being adapted to the properties of the oil-based dispersed particles, i.e. designed depending on the components for emulsification. In this regard, it has been difficult to provide a cleaning agent responsible for various types of oil components.

In addition, oil components of recent years as objects to be cleaned may often be ones mixed thereto with surfactants rather than being comprised only of simple mineral oils. This trend is notable in machining oils, and such mixed oils have been common as water soluble machining oils. Surfactants contained in such water soluble machining oils may function as inhibitory factors in view of facilitating the separability of oil components, but there are few cases where the ingredients thereof are disclosed. Also in this regard, it is extremely difficult to provide a general-purpose cleaning agent which is responsible for various types of oil components and which has excellent oil separability.

Although various inventions focusing oil separability have heretofore been disclosed (e.g. Patent Document 1), applicability to water soluble machining oils may not necessarily be sufficient.

[Patent Document 1] Published Patent Application No. 2000-336391

### SUMMARY OF THE INVENTION

### Problem to be Solved by the Invention

In view of such circumstances, an object of the present invention is to provide a general-purpose aqueous cleaning agent composition which has oil separability adaptable even to water soluble machining oils and which is applicable to various types of oil components.

### Means for Solving the Problem

An aqueous cleaning agent composition having oil separability according to one aspect of the present invention, which is provided for solving the above one or more problems, includes: an emulsifying agent that removes an oil component from a member subjected to cleaning to which the oil component is adhering and emulsifies the oil component; a separating agent comprised of an anionic polymer; and a separating auxiliary agent comprised of a cationic surfactant.

The “emulsifying agent” as used herein refers to a component capable of, such as, removing oil components from a member subjected to cleaning to which the oil components are adhering thereby causing the oil component to be fine particles, and forming micelles which contain such fine oil components. That is, examples of the emulsifying agent in the present invention also include compounds referred to as so-called emulsion stabilizing agents, such as surfactants. Examples of substances for removing oil components from a member subjected to cleaning include alkaline inorganic salts, such as silicate salt, and alkaline metal hydroxides, such as sodium hydroxide. While examples of the surfactant typically include an anionic surfactant, a nonionic surface active agent may also be used. The surfactant may also be comprised of plural components.

The “separating agent” as used herein refers to a component that aggregates emulsified oil components to separate them from the aqueous liquid phase, and is comprised of anionic polymer in the present invention. The “anionic polymer” as used herein refers to an organic substance, obtained by polymerizing one type or plural types of monomers and having a molecule weight of approximately 1000 or more after being polymerized, which is a water soluble substance dissolved in the aqueous liquid phase in a state of having negative electric charge as whole molecule. Typical examples thereof include polyacrylic acid ion. It is preferred that the molecular weight of the anionic polymer is 1500 or more and 50000 or less.

The “separating auxiliary agent” as used herein is a component that is necessary for the separating agent to accomplish its functionality, and intervenes between the above-described oil-based dispersed particles and the separating agent thereby to accomplish a function that allows them to come together to be separated from the aqueous liquid phase. The separating auxiliary agent in the present invention is comprised of a cationic surfactant.

It is preferred that the HLB value of the separating auxiliary agent is a value of 26 or more as defined by the Davies' method.

In view of enhancing the cleaning ability, it is preferred that the emulsifying agent comprises an alkaline component and a surfactant, wherein the alkaline component is comprised of one or more selected from the group consisting of alkaline metal hydroxides and alkaline inorganic salts.

Note that “having oil separability” in the present invention means that the aqueous cleaning agent composition containing the separating agent and the separating auxiliary agent according to the present invention has a higher ability of separating the emulsified oil components as an oil phase compared to that of an aqueous cleaning agent composition obtained by removing the separating agent from the aqueous cleaning agent composition according to the present invention. This ability may be quantitatively evaluated by measuring an absorbance of the cleaning agent composition containing oil-based dispersed particles to estimate the concentration of the oil-based dispersed particles in the composition.

As another aspect of the present invention, a composition for cleaning agent is provided for preparing the above aqueous cleaning agent composition. This composition for cleaning agent comprises: a component for emulsifying agent, capable of forming the emulsifying agent in a liquid containing water as a main constituent; a component for separating agent, capable of forming the separating agent in that liquid; and a component for separating auxiliary agent, capable of forming the separating auxiliary agent in that liquid.

### Advantageous Effect of the Invention

The aqueous cleaning agent composition according to the present invention contains the emulsifying agent as a component for causing oil components, which are adhering to the surface of a member subjected to cleaning, to be emulsified oil components, contains the separating agent for separating oil-based dispersed particles from the aqueous liquid phase, and further contains the separating auxiliary agent allowing the separating agent to act on the oil-based dispersed particles. Accordingly, the emulsification of oil components and the aggregation and separation of oil-based dispersed particles are stably performed irrespective of the type of oil component or the type of surface active agent mixed in therewith.

Therefore, according to the present invention, even for water soluble machining oils that contain surfactants, it is achieved to rapidly remove the oil components thereof from the member subjected to cleaning and to efficiently separate the oil components.

### BEST MODES FOR CARRYING OUT THE INVENTION

Descriptions will be directed to the components of the aqueous cleaning agent composition and the components of the composition for cleaning agent according to the present invention and other matters.

1. Aqueous Cleaning Agent Composition

The aqueous cleaning agent composition having oil separability according to the present invention includes: an emulsifying agent that removes an oil component from a member subjected to cleaning to which the oil component is adhering and emulsifies the oil component; a separating agent comprised of an anionic polymer; and a separating auxiliary agent comprised of a cationic surfactant.

(1) Emulsifying Agent

The “emulsifying agent” according to the present invention refers to a component that has a function of removing oil components from a member subjected to cleaning to which the oil components are adhering (this function will hereinafter be referred to as “removing function”) and/or a function of causing a state where the removed oil components can be suspended in the aqueous liquid phase for a long time as being oil-based dispersed particles (this action will hereinafter be referred to as “emulsifying function”). Therefore, the “emulsifying agent” in the present invention also involves compounds referred to as so-called emulsion stabilizing agents, such as surfactants.

Specific composition of the emulsifying agent is not particularly limited as long as the emulsifying agent as a whole has at least one of the removing function and the emulsifying function. Examples of the emulsifying agent typically include surfactants, alkaline inorganic salts and alkaline metal hydroxides. In the present invention, alkaline inorganic salts and alkaline metal hydroxides are collectively referred to as “alkaline components”. That is, the alkaline components in the present invention are comprised of one or more selected from the group consisting of alkaline metal hydroxides and alkaline inorganic salts.

Specific examples of surfactants include anionic surfactants, nonionic surfactants, ampholytic surface active agents and semi-polar surfactants.

Examples of anionic surfactants specifically include polyoxyethylene alkyl sulfate, alkyl or alkenyl sulfate, polyoxyethylene alkyl or alkenyl sulfate ester, alkyl benzene sulfonate, alkane sulfonate, alkyl or alkenyl ether carboxylate, α-sulfo fatty acid derivative, α-olefin sulfonate, α-sulfo fatty acid alkyl ester salt, sulfosuccinate, alkyl phosphoric ester salt, natural fatty acid soap, alkyl ethoxy sulfate, amide ether carboxylic acid, amino-acid-based anionic activating agent and other agents.

Examples of nonionic surfactants specifically include polyoxyalkylene alkyl ether, fatty acid alkanolamide, polyoxyethylene sorbitan ester, sorbitan ester, sorbitol ester, sucrose fatty acid ester, methyl glucoside ester, methylmannoside ester, ethyl glucoside ester, N-methylglucamide, cyclic N-methylglucamide, alkyl glucoside, alkyl polyglucoside, alkyl glyceryl ether, polyoxyethylene alkyl ether, sorbitan fatty acid ester, polyoxyethylene acyl ester, fatty acid glycoside ester, fatty acid methyl glycoside ester, alkyl methyl glucamide and other agents.

Examples of ampholytic surfactants specifically include carboxybetaine, aminocarboxylate, alkyl sulfobetaine, hydroxyalkyl sulfobetaine, alkyl imidazolinium betaine, alkyl betaine, alkyl amidopropyl betaine and other agents.

Examples of semi-polar surfactants specifically include alkyl amine oxide, alkyl amide amine oxide, alkyl hydroxy amine oxide and other agents.

Among these surfactants, anionic surfactants and nonionic surfactants are preferable. Specific examples of preferred surfactants include sodium alkyl ether sulfate ester, sodium alkylbenzene sulfonate, polyoxyethylene alkyl ether, coconut fatty acid alkanol amide and fatty acid amide propyl betaine.

If the emulsifying agent comprises a surfactant, it is preferred that the hydrophilic moiety of the surfactant, i.e. a moiety to form the outer side thereof when forming a micelle structure, has a chemical structure that facilitates an interaction with the hydrophilic moiety of the separating auxiliary agent comprised of a cationic surfactant which will be described later. In this regard, if the emulsifying agent has a surfactant, the surfactant is preferred to have an anionic functional group or an electron-donating functional group.

An alkaline metal hydroxide, one of the alkaline components, is a metal hydroxide that exhibits alkaline property in water, and saponifies oil components on the surface of a member subjected to cleaning thereby facilitating the emulsification. Examples thereof typically include sodium hydroxide and potassium hydroxide.

An alkaline inorganic salt, the other of the alkaline components, is an inorganic salt that exhibits alkaline property in water, and examples thereof include sodium carbonate, sodium bicarbonate (sodium hydrogen carbonate), sodium sulfite, sodium sesquicarbonate, sodium silicate, crystalline layered sodium silicate and amorphous layered sodium silicate.

The emulsifying agent is preferred to contain both the alkaline inorganic salt and the alkaline metal hydroxide.

The composition of the emulsifying agent may be of a single component, or may be comprised of plural types of substances. The emulsifying agent is preferred to have both the removing function and the emulsifying function. In this regard, the emulsifying agent is preferred to comprise one or more alkaline components and one or more surfactants.

The contained amount of the emulsifying agent is appropriately set such that the above removing function and the emulsifying function are stably achieved in consideration of the type and the amount of oils that adhere to a member subjected to cleaning. If the contained amount of the emulsifying agent is unduly small, then the removing function can of course not be achieved. If, on the other hand, the contained amount of the emulsifying agent is unduly large, then the amount of the emulsifying agent to be discarded without achieving its function increases, and the load in wastewater treatment facilities may possibly be increased. In addition, this leads to the increase in the emulsifying agent and the emulsifying auxiliary agent that do not contribute to causing the emulsified oil components to be an oil phase thereby increasing disadvantages in economic terms.

(2) Separating Agent

The “separating agent” according to the present invention refers to a component that has a function of aggregating the emulsified oil components to separate them from the aqueous liquid phase (referred hereinafter to as “separating function”), and is comprised of an anionic polymer in the present invention.

The “anionic polymer” as used herein refers to an organic substance, obtained by polymerizing one type or plural types of monomers and having a molecule weight of approximately 1000 or more after being polymerized, which is a water soluble substance dissolved in the aqueous liquid phase in a state of having negative electric charge as whole molecule. This negative electric charge is resulted from the polymer having an anionic functional group (referred hereinafter to as “anionic group”). Examples of such an anionic group include —SO₃⁻, —COO⁻, —CH₂PO₃⁻ and other groups. Polyacrylic acid ion may be mentioned as the most typical example of the anionic polymer.

Although the action of the separating function achieved by the anionic polymer is not definitive, it appears as follows. That is, the anionic group of the anionic polymer is integrated with the oil-based dispersed particles via the separating auxiliary agent which will be described later. Main chain portions of the anionic polymer integrated with the oil-based dispersed particles are tangled with one another, and the anionic polymer thereby aggregates while holding the emulsified oil components. The emulsified oil components are also aggregated to form an oil phase as the anionic polymer aggregates, thereby being separated from the aqueous liquid phase.

Specific structure and properties of the anionic polymer, such as the molecular weight and the HLB value, are not particularly limited as long as the above separating function is achieved.

If the molecular weight of the anionic polymer is unduly small, then the aggregation of the anionic polymer based on the tangling of main chains is unlikely to occur. Therefore, the separating function may still be low even if the contained amount of the anionic polymer is increased. If, on the other hand, the molecular weight of the anionic polymer is unduly large, then the separating function may also be deteriorated because the anionic polymer in large part solely aggregates in a state before holding oil components or considerable aggregation occurs on the basis of association of these polymer molecules even when the contained amount of the anionic polymer is small. Molecule weight of 1500 or more and 50000 or less of the anionic polymer allows the separating function to stably develop over a wide range of the contained amount of the anionic polymer, thus being preferable.

In addition, if the HLB value of the anionic polymer is unduly small, that is, the existing density of the anionic groups in the anionic polymer is unduly small and the lipophilicity is excessively high, then the anionic polymer may not function as the separating agent because the anionic polymer does not readily dissolve into the aqueous liquid phase. Preferable HLB value of the anionic polymer is 26 or more as an HLB value according to the Davies' method.

Moreover, as long as the anionic polymer has negative electric charge as whole molecule, the anionic polymer may have an additional group other than the anionic group, for example, a functional group that is easy to interact with water, such as hydroxyl group and ether group, or a cationic group. Appropriately including such an additional group allows for adjusting the HLB value of the anionic polymer.

The composition of the separating agent may be of a single component, or may contain plural types of anionic polymers.

The contained amount of the separating agent is appropriately set such that the above separating function is stably achieved. If the contained amount of the separating agent is unduly small, then the separating function can of course not be achieved. If, on the other hand, the contained amount of the separating agent is unduly large, then the anionic polymer as the separating agent considerably aggregates without interacting with the oil-based dispersed particles, and problems may thus be concerned, such as deterioration in the separating function and increase in load of wastewater treatment facilities.

It is noted that, in a case where the contained amount is the same, the deterioration in the separating function due to the anionic polymer molecules aggregating one another is less likely to occur as the polymer number concentration of the anionic polymer (contained amount/molecular weight) increases. Therefore, if the contained amount of the anionic polymer is required to be increased, it is preferred that the molecular weight of the anionic polymer is decreased.

(3) Separating Auxiliary Agent

The “separating auxiliary agent” in the present invention is a component that is necessary for the above separating agent to accomplish the separating function. Even if the emulsifying agent and the separating agent are present, when the separating auxiliary agent is absent, the emulsified oil components having been removed from a member subjected to cleaning cannot form an oil phase to be separated from the aqueous liquid phase. Although the functionality of the separating auxiliary agent is not definitive, the separating auxiliary agent may intervenes between the above-described oil-based dispersed particles and the separating agent thereby to accomplish the function that allows them to come together to be separated from the aqueous liquid phase (referred hereinafter to as “intervening function”).

In the present invention, this separating auxiliary agent is comprised of a cationic surfactant. The type thereof is not particularly limited as long as it can accomplish the above intervening function. Specific examples thereof include di-long chain alkyl dimethyl quarternary ammonium ion, long chain alkyl dimethyl quarternary ammonium ion, alkyl ammonium ion and quarternary ammonium ion. These are blended in a form of such as hydrochloride salt in general.

The composition of the separating auxiliary agent may be of a single component, or may contain plural types of cationic surfactants.

If the contained amount of the separating auxiliary agent is unduly small, then the intervening function cannot be achieved. If, on the other hand, the contained amount of the separating auxiliary agent is unduly large, then the separating auxiliary agent may inhibit the removing function and the emulsifying function, which are basic functions of the emulsifying agent. Therefore, the contained amount of the separating auxiliary agent may be set in view of stably achieving the intervening function without inhibiting these basic functions of the emulsifying agent.

The oil-based dispersed particles include ones having micelle structures when the emulsifying agent contains a surfactant. In this case, if the contained amount of the separating auxiliary agent is unduly large, then the effects due to the interaction between the cationic surfactant as the separating auxiliary agent and the surfactant contained in the emulsifying agent may become significant. Then, there are concerns such as that the separating auxiliary agent inhibits the surfactant contained in the emulsifying agent from forming micelle structures and that the separating auxiliary agent decomposes the formed micelle structures. If such phenomena become obvious, the emulsifying agent will not readily achieve the above basic functions. Therefore, in a case where the emulsifying agent contains a surfactant, it is preferred that the contained amount of the emulsifying agent and the contained amount of the separating auxiliary agent are set in consideration of the above effects due to the above interaction. In this regard, a preferable range exists for a mass ratio of the contained amount of the separating auxiliary agent to that of the surfactant contained in the emulsifying agent, and the degree of the above interaction affects the upper limit of the range.

In addition, the separating auxiliary agent appears to interact with respective hydrophilic moieties of the oil-based dispersed particle and the separating agent thereby to achieve a function of connecting therebetween, and therefore, it is preferred that the separating auxiliary agent is large in the degree of hydrophilicity as whole molecule and the HLB value thereof is a value of 26 or more as defined by the Davies' method.

(4) Other Components

Any additional component may be contained in the aqueous cleaning agent composition according to the present invention as long as the above three components are contained therein and the functions of these components are not significantly inhibited. Examples of such additional components include sequestering agents, neutral inorganic salts, antifoam agents and corrosion inhibitors.

Examples of sequestering agents include phosphoric acids (orthophosphoric acid, pyrophosphoric acid, tripolyphosphoric acid, tetraphosphoric acid and hexametaphosphoric acid) and organic acids (oxalic acid, malonic acid, malic acid, tartaric acid, L-ascorbic acid and lactic acid), salts thereof representing organic compounds that have chelate action, and inorganic substances that adsorb metal ions, such as zeolite.

Neutral inorganic salts that have an action for enhancing the surface activating ability of the surfactant may also be contained, such as sodium sulfate decahydrate.

Examples of the antifoam agents include silicon oil, and examples of the corrosion inhibitors include benzotriazole.

(5) Solvent for Aqueous Liquid Phase

The main constituent of liquid that constitutes the aqueous liquid phase in the aqueous cleaning agent composition according to the present invention is water. That is, the main solvent of the aqueous cleaning agent composition according to the present invention is water. In view of adjusting the solubility of contained components and other purposes, a water soluble organic solvent may also be contained, such as alcohol, ether and ketone. However, excessively containing such a water soluble organic solvent may lead to problems such as that the emulsified oil components are not readily formed and that an oil phase based on the emulsified oil components is not readily separated. Accordingly, it is preferred that the upper limit of the contained amount of water soluble organic solvent is 10 mass % to water.

(6) Composition for Cleaning Agent

The aqueous cleaning agent composition according to the present invention can be easily prepared by providing a composition for cleaning agent that contains components (referred to as “component for emulsifying agent”, “component for separating agent” and “component for separating auxiliary agent” in the present invention) capable of forming, in the aqueous liquid phase, the above respective three essential components in the aqueous cleaning agent composition according to the present invention.

Here, the “component for emulsifying agent”, “component for separating agent” and “component for separating auxiliary agent” may be the emulsifying agent itself, the separating agent itself and the separating auxiliary agent itself, respectively, or may be different ones. For example, if the component for separating agent used for an anionic polymer as the separating agent or the component for separating auxiliary agent used for a cationic surfactant as the separating auxiliary agent is provided as a solid substance, then a form of salt will easily be employed which includes counter ions (such as sodium ion and chloride ion). Alternatively, or in addition to this, an anionic polymer as the separating agent in which a part or whole of the anionic groups are caused to be ester groups may be provided as the component for separating agent, so that the anionic polymer will be formed when that component for separating agent is dissolved into water.

Note that, if the aqueous cleaning agent composition according to the present invention contains the previously-described other components, the other components may preliminarily be contained in the composition for cleaning agent, or the other components may be to be contained in a liquid form composition obtained by dissolving the composition for cleaning agent into water.

3. Member Subjected to Cleaning

The shape and the composition of a member subjected to cleaning, which is an article to be an object subjected to cleaning, are not particularly limited. If the member subjected to cleaning has a complex shape, then the emulsifying agent as a component of the cleaning agent may be selected as having high emulsifying function or the contained amount of the emulsifying agent may be increased. If the member subjected to cleaning has corrosivity, then the components of the cleaning agent may be adjusted so that the pH of degreasing liquid is neutral.

4. Oil Component

The composition of oil component subjected to being removed by the cleaning agent composition according to the present invention is not particularly limited. It may be comprised of simple mineral oil or may be water soluble machining oil that contains surface active agent and/or other components. The surfactant to be blended in such water soluble machining oil may be nonionic-type surfactant or anionic-type surfactant.

### EXAMPLES

Various possible aspects of the present invention will hereinafter be described in detail as examples, but the present invention is not limited to these examples.

### Example 1

1. Preparation of Cleaning Agent for Evaluation

Respective components shown in Table 1 were dissolved into water, and plural types of cleaning agents were prepared. Each pH of these cleaning agents was approximately 12.5. Each cleaning agent was added thereto with 20 ml/L of machining oil C-164M (available from Sugimura Chemical Industrial Co., Ltd.) as an aqueous machining oil containing a nonionic surfactant, and the cleaning agent added thereto with that machining oil was stirred using a mixer to prepare a simulant aged liquid.

TABLE 1

| | | | Test symbol | | | | | | | | | | |
|---|---|---|---|---|---|---|---|---|---|---|---|---|---|
| | | | 1 | 2 | 3 | 4 | 5-1~5-7 | 6-1~6-7 | 7-1~7-7 | 8-1~8-7 | 9-1~9-7 | 10-1~10-7 | 11-1~11-7 |
| Sodium hydroxide | | g/L | 8 | 8 | 8 | 8 | 8 | 8 | 8 | 8 | 8 | 8 | 8 |
| Sodium silicate pentahydrate | | g/L | 3 | 3 | 3 | 3 | 3 | 3 | 3 | 3 | 3 | 3 | 3 |
| Polyoxyethylene polyoxypropylene | | g/L | 3 | 3 | 3 | 3 | 3 | 3 | 3 | 3 | 3 | 3 | 3 |
| tridecyl ether | | | | | | | | | | | | | |
| Benzalkonium chloride | | g/L | | 0.5 | 1.0 | | 0.5 | 0.5 | 0.5 | 0.5 | 0.5 | 0.5 | 0.5 |
| Sodium | Average molecular weight: | g/L | | | | 0.2 | Either one | Either one | Either one | Either one | Either one | Either one | Either one |
| polyacrylate | 70000 | | | | | | type of | type of | type of | type of | type of | type of | type of |
| | Average molecular weight: | g/L | | | | | 0.01 | 0.05 | 0.1 | 0.2 | 0.5 | 1.0 | 2.0 |
| | 50000 | | | | | | | | | | | | |
| | Average molecular weight: | g/L | | | | | | | | | | | |
| | 30000 | | | | | | | | | | | | |
| | Average molecular weight: | g/L | | | | | | | | | | | |
| | 20000 | | | | | | | | | | | | |
| | Average molecular weight: | g/L | | | | | | | | | | | |
| | 12000 | | | | | | | | | | | | |
| | Average molecular weight: | g/L | | | | | | | | | | | |
| | 3000 | | | | | | | | | | | | |
| | Average molecular weight: | g/L | | | | | | | | | | | |
| | 1500 | | | | | | | | | | | | |

Note that the alkyl group of benzalkonium chloride shown in Table 1 had 12 to 14 carbon atoms and that the HLB based on the Davies' method of the benzalkonium chloride was approximately 27.

2. Evaluating Method

(1) Evaluation of Cleaning Ability

Steel plates of SPCC-SD (10 cm×5 cm, thickness: 0.8 mm) were applied thereto with the machining oil, which was used for preparing the above simulant aged liquid. The quantity of application was approximately 1000 mg per each steel plate. After being immersed in each cleaning agent maintained at 50° C. during 5 minutes, the steel plates applied thereto with the machining oil were taken out from the cleaning agent to be subjected to water washing (immersion in water bath of a water temperature of 25° C. during 10 seconds while being swung). Water-wetted area ratio was measured for the surface of each steel plate after the water washing for the purpose of evaluating the cleaning ability. A water-wetted area ratio less than 90% was determined as being poorly cleaned.

(2) Evaluation of Oil Separability

After each simulant aged liquid remained stationary overnight at room temperature, 1 mL of the cleaning liquid was sampled from the intermediate layer (portion other than floating oil of the upper layer and precipitation of the lower layer), and the sampled cleaning liquid was diluted by 100 times using ion-exchanged water.

The diluted liquid obtained in such a manner was subjected to absorbance measurement at a wavelength of 400 nm using an absorptiometer. The reason for setting the measurement wavelength at 400 nm is that the maximum absorbance under white light is obtained for emulsion within that wavelength region.

The absolute value of the absorbance was used as the basis for the evaluation, and it was determined as being improved in the separability if the absolute value was less than that of the cleaning liquid according to Test No. 2 (a case where the contained amount of the separating auxiliary agent was appropriate, but no separating agent was contained).

3. Evaluation Result

The evaluation result is shown in Table 2.

TABLE 2

| | Molecular | Cleaning ability | Separability (absorbance) | | | | | | |
|---|---|---|---|---|---|---|---|---|---|
| Test symbol | weight | (surface ratio) | 0.01 g/L | 0.05 g/L | 0.1 g/L | 0.2 g/L | 0.5 g/L | 1.0 g/L | 2.0 g/L |
| 1 | | 100 | 0.159 | | | | | | |
| 2 | | 95 | 0.050 | | | | | | |
| 3 | | 40 | 0.011 | | | | | | |
| 4 | | 95 | 0.169 | 0.172 | 0.188 | 0.198 | 0.223 | 0.267 | 0.291 |
| 5-1~11-1 | 70000 | 95 | 0.063 | 0.061 | 0.062 | 0.049 | 0.050 | 0.062 | 0.072 |
| 5-2~11-2 | 50000 | 95 | 0.058 | 0.059 | 0.047 | 0.046 | 0.047 | 0.063 | 0.072 |
| 5-3~11-3 | 30000 | 95 | 0.049 | 0.047 | 0.045 | 0.017 | 0.012 | 0.023 | 0.061 |
| 5-4~11-4 | 20000 | 95 | 0.050 | 0.021 | 0.012 | 0.008 | 0.009 | 0.008 | 0.057 |
| 5-5~11-5 | 12000 | 95 | 0.048 | 0.007 | 0.006 | 0.006 | 0.007 | 0.015 | 0.053 |
| 5-6~11-6 | 3000 | 95 | 0.047 | 0.005 | 0.005 | 0.005 | 0.012 | 0.015 | 0.051 |
| 5-7~11-7 | 1500 | 95 | 0.050 | 0.005 | 0.004 | 0.006 | 0.009 | 0.011 | 0.050 |

Table 2 reveals the followings:

(1) If no polyacrylic acid as the separating agent is contained and only benzalkonium ion as the separating auxiliary agent is contained, then the cleaning ability significantly deteriorates as the contained amount thereof increases;

(2) If no separating auxiliary agent is contained and only the separating agent is contained, then the separability is not observed to be improved, and the absorbance rather increases as the contained amount of the separating agent increases;

(3) The separability is observed to be improved by containing the separating agent and the separating auxiliary agent; and

(4) If the separating agent and the separating auxiliary agent are present, then the separability is improved as the polymer number concentration of the anionic polymer as the separating agent increases.

### Example 2

Results obtained by changing oil component subjected to being removed will be presented below.

The machining oil C-164M used in Example 1 was substituted by HIGHCLEAN CF-50 and HIGHCLEAN CFK (both available from Sanyo Chemical Industries, Ltd.), both being aqueous machining oils and containing an anionic surfactant, and evaluations (evaluation of cleaning ability and evaluation of oil separability) were performed like Example 1. In addition, after remaining stationary overnight at room temperature for the evaluation of oil separability, each simulant aged liquid was observed in its appearance to be evaluated in accordance with the following criteria (appearance evaluation). Among samples subjected to the evaluation, ones evaluated as being “A”, “B” and “C” were determined to be acceptable while ones evaluated as being “D” were determined to be unacceptable, where

A (excellent): Phases were definitely separated to form an oil phase as the uppermost layer, and the aqueous phase below the oil phase was transparent;

B (good): Phases were definitely separated to form an oil phase as the uppermost layer, but the aqueous phase below the oil phase was clouded;

C (acceptable): Definitive phase separation was not observed, but some emulsification was confirmed, and the liquid phase thereof was semi-transparent or clouded; and

D (unacceptable): Definitive phase separation was not observed, and the liquid phase thereof was transparent.

The evaluation results are shown in Table 3 (HIGHCLEAN CF-50) and Table 4 (HIGHCLEAN CFK).

TABLE 3

| | | Test symbol | | | | |
|---|---|---|---|---|---|---|
| | | 20-1 | 20-2 | 20-3 | 20-4 | 20-5 |
| Sodium hydroxide | g/L | 8 | 8 | 8 | 8 | 8 |
| Sodium silicate pentahydrate | g/L | 3 | 3 | 3 | 3 | 3 |
| Polyoxyethylene | g/L | 3 | 3 | 3 | 3 | 3 |
| polyoxypropylene tridecyl ether | | | | | | |
| Benzalkonium chloride | g/L | 0 | 0.1 | 0.3 | 0.5 | 0.7 |
| Sodium polyacrylate | g/L | 0.2 | 0.2 | 0.2 | 0.2 | 0.2 |
| (molecular weight: 3000) | | | | | | |
| Absorbance | | 0.292 | 0.089 | 0.021 | 0.016 | 0.005 |
| Evaluation | | D | C | B | B | A |

TABLE 4

| | | Test symbol | | | | |
|---|---|---|---|---|---|---|
| | | 21-1 | 21-2 | 21-3 | 21-4 | 21-5 |
| Sodium hydroxide | g/L | 8 | 8 | 8 | 8 | 8 |
| Sodium silicate pentahydrate | g/L | 3 | 3 | 3 | 3 | 3 |
| Polyoxyethylene | g/L | 3 | 3 | 3 | 3 | 3 |
| polyoxypropylene tridecyl ether | | | | | | |
| Benzalkonium chloride | g/L | 0 | 0.1 | 0.3 | 0.5 | 0.7 |
| Sodium polyacrylate | g/L | 0.2 | 0.2 | 0.2 | 0.2 | 0.2 |
| (molecular weight: 3000) | | | | | | |
| Absorbance | | 0.316 | 0.075 | 0.025 | 0.018 | 0.009 |
| Evaluation | | D | C | B | B | A |

### Example 3

Results obtained by changing the composition of emulsifying agent will then be presented below.

Examples 1 and 2 employed an emulsifying agent comprised of sodium hydroxide, sodium silicate pentahydrate and polyoxyethylene polyoxypropylene tridecyl ether. Evaluations (evaluation of cleaning ability, evaluation of oil separability and appearance evaluation) like Example 2 were performed in cases of using emulsifying agents comprised of other compositions. Note that the aqueous machining oil added to each cleaning agent was the same machining oil C-164M as Example 1.

Evaluation results are presented in Tables 5 and 6.

TABLE 5

| | | Test symbol | | | | | | |
|---|---|---|---|---|---|---|---|---|
| | | 30-1 | 30-2 | 30-3 | 30-4 | 30-5 | 30-6 | 30-7 |
| Sodium | g/L | 8 | | | 8 | | | 8 |
| hydroxide | | | | | | | | |
| Sodium silicate | g/L | | 3 | | | 3 | | 3 |
| pentahydrate | | | | | | | | |
| Polyoxy- | g/L | | | 3 | | | 3 | 3 |
| ethylene | | | | | | | | |
| polyoxy- | | | | | | | | |
| propylene | | | | | | | | |
| tridecyl ether | | | | | | | | |
| Sodium | g/L | 0 | 0 | 0 | 0.2 | 0.2 | 0.2 | 0.2 |
| polyacrylate | | | | | | | | |
| (molecular | | | | | | | | |
| weight: 3000) | | | | | | | | |
| Benzalkonium | g/L | 0 | 0 | 0 | 0.5 | 0.5 | 0.5 | 0.5 |
| chloride | | | | | | | | |
| Cleaning | | 5 | 5 | 5 | 5 | 5 | 5 | 95 |
| ability | | | | | | | | |
| Absorbance | | 0.163 | 0.235 | 0.287 | 0.015 | 0.032 | 0.046 | 0.005 |
| Evaluation | | D | D | D | B | B | B | A |

TABLE 6

| | | Test symbol | | | | | | | |
|---|---|---|---|---|---|---|---|---|---|
| | | 30-8 | 30-9 | 30-10 | 30-11 | 30-12 | 30-13 | 30-14 | 30-15 |
| Sodium hydroxide | g/L | 8 | 16 | 32 | 64 | | | | |
| Sodium silicate pentahydrate | g/L | | | | | 3 | 6 | 12 | 24 |
| Polyoxyethylene polyoxypropylene | g/L | 3 | 3 | 3 | 3 | 3 | 3 | 3 | 3 |
| tridecyl ether | | | | | | | | | |
| Sodium polyacrylate | g/L | 0.2 | 0.2 | 0.2 | 0.2 | 0.2 | 0.2 | 0.2 | 0.2 |
| (molecular weight: 3000) | | | | | | | | | |
| Benzalkonium chloride | g/L | 0.5 | 0.5 | 0.5 | 0.5 | 0.5 | 0.5 | 0.5 | 0.5 |
| Cleaning ability | | 80 | 80 | 85 | 85 | 80 | 90 | 95 | 98 |
| Absorbance | | 0.018 | 0.012 | 0.005 | 0.003 | 0.049 | 0.047 | 0.045 | 0.038 |
| Evaluation | | B | A | A | A | B | B | B | B |

### Example 4

In addition, results obtained by changing the HLB value of the separating auxiliary agent will be presented below.

Examples 1 and 2 employed a separating auxiliary agent having an HLB value of approximately 27 based on the Davies' method. Evaluations (evaluation of cleaning ability, evaluation of oil separability and appearance evaluation) like Example 2 were performed in cases of varing the HLB value from about 24.5 to about 29.2. Note that the HLB value of the separating auxiliary agent was varied by changing, from 8 to 18, the number of carbons constituting the alkyl group in benzalkonium chloride blended as the separating auxiliary agent. Note also that the aqueous machining oil added to each cleaning agent was the same machining oil C-164M as Example 1.

Evaluation results are presented in Tables 7.

TABLE 7

| | | | Test symbol | | | | | |
|---|---|---|---|---|---|---|---|---|
| | | | 40-1 | 40-2 | 40-3 | 40-4 | 40-5 | 40-6 |
| Sodium hydroxide | | g/L | 8 | 8 | 8 | 8 | 8 | 8 |
| Sodium silicate pentahydrate | | g/L | 3 | 3 | 3 | 3 | 3 | 3 |
| Polyoxyethylene polyoxypropylene | | g/L | 3 | 3 | 3 | 3 | 3 | 3 |
| tridecyl ether | | | | | | | | |
| Sodium polyacrylate | | g/L | 0.2 | 0.2 | 0.2 | 0.2 | 0.2 | 0.2 |
| (molecular weight: 3000) | | | | | | | | |
| Benzalkonium | R = 8, HLB = 24.48 | g/L | 0.5 | | | | | |
| chloride | R = 10, HLB = 25.43 | | | 0.5 | | | | |
| | R = 12, HLB = 26.38 | | | | 0.5 | | | |
| | R = 14, HLB = 27.33 | | | | | 0.5 | | |
| | R = 16, HLB = 28.28 | | | | | | 0.5 | |
| | R = 18, HLB = 29.22 | | | | | | | 0.5 |

| | | | | | | |
|---|---|---|---|---|---|---|
| Absorbance | 0.083 | 0.057 | 0.016 | 0.005 | 0.004 | 0.004 |
| Evaluation | D | C | B | B | A | A |

1. An aqueous cleaning agent composition having oil separability, comprising:
an emulsifying agent that removes an oil component from a member subjected to cleaning to which the oil component is adhering and emulsifies the oil component;
a separating agent comprised of an anionic polymer having a molecule weight of 1500 or more and 50000 or less; and
a separating auxiliary agent comprised of a cationic surfactant.

2. (canceled)

3. The aqueous cleaning agent composition as set forth in claim 1, wherein the separating auxiliary agent has an HLB value of 26 or more as a value defined by Davies' method.

4. The aqueous cleaning agent composition as set forth in claim 1, wherein the emulsifying agent comprises an alkaline component and a surfactant, and the alkaline component is comprised of one or more selected from the group consisting of alkaline metal hydroxides and alkaline inorganic salts.

5. A composition for cleaning agent, the composition being for preparing an aqueous cleaning agent composition comprising: an emulsifying agent that removes an oil component from a member subjected to cleaning to which the oil component is adhering and emulsifies the oil component; a separating agent comprised of an anionic polymer; and a separating auxiliary agent comprised of a cationic surfactant,
the composition for cleaning agent comprising:
a component for emulsifying agent, capable of forming the emulsifying agent in a liquid containing water as a main constituent;
a component for separating agent, capable of forming the separating agent in the liquid; and
a component for separating auxiliary agent, capable of forming the separating auxiliary agent in the liquid.

6. The composition for cleaning agent as set forth in claim 5, wherein the emulsifying agent comprises an alkaline component and a surfactant, and the alkaline component is comprised of one or more selected from the group consisting of alkaline metal hydroxides and alkaline inorganic salts.
